(19) United States
(12) Patent Application Publication
(10) Pub. No.: US 2025/0146535 A1
(43) Pub. Date: May 8, 2025

(54) Coupler for drive lines

(71) Applicant: XCAD VALVE AND IRRIGATION, INC, Paul, ID (US)

(72) Inventor: Don D. Duffin, Paul, ID (US)

(21) Appl. No.: 18/917,740

(22) Filed: Oct. 16, 2024

Related U.S. Application Data
(60) Provisional application No. 63/596,938, filed on Nov. 7, 2023.

(51) Int. Cl. F16D 3/12

(52) U.S. Cl. CPC F16D 3/12; F16D 3/68; F16D 3/78

(57) ABSTRACT

A driveline coupler for an irrigation system having a puck that is press fit into the driveline coupler. The driveline coupler connects the motor or gearbox to the driveline of the irrigation system. The driveline coupler does not utilize bolts positioned through the puck to secure the puck in the universal connector.

### CROSS-REFERENCE TO RELATED APPLICATIONS

This application claims the benefit of U.S. Provisional Application No. 63/596,938, filed Nov. 7, 2023 the disclosure of which is incorporated by reference.

### TECHNICAL FIELD

The present invention relates generally to the field of couplers used for connecting a driving shaft to a driven shaft, more specifically to a universal coupler for use in coupling drive wheels to an input power in irrigation systems.

### BACKGROUND OF THE INVENTION

One type of irrigation system is an overhead irrigation system. In a typical overhead irritation system, such as a center pivot system or lateral move system, a series of spaced apart support towers support an elevated water distribution pipe. The towers each have a set of wheels and a central drive motor which drives the wheels. In a center pivot the support system extends from a fixed point, with the system pivoting about this central pivot point. In a lateral drive system both ends of the support system move, as well as any intermediary support towers. In both systems water is delivered through the water distribution pipe to suspended sprinklers that deliver the water to the crop below. The wheels are driven by a center drive motor with a gearbox. The drive system utilizes a driveshaft between the center drive gearbox and a gearbox on each driven wheel. A universal coupler (also called a universal joint) is used to connect each end of the driveshaft to the center drive gearbox and driven wheel gearboxes while allowing for misalignment between the gearbox shafts. These universal couplers typically have two end members to connect to the gearbox shaft and driveshaft, respectively, and have a flexible, resilient center puck to which the end members connect to allow for the misalignment and shock absorption. This allows the universal coupler to flex and absorb driveline shock and vibration while still transferring torque from one shaft to the other.

Traditionally, each of the two universal coupler end members have two halves that clamp around the puck and shaft at the same time and are secured together with multiple relatively small nuts and bolts. This system is cumbersome to install and it is difficult to not drop or break the relatively small bolts. Another common universal coupler utilizes solid, single-piece end members which can withstand greater torque and use larger and fewer bolts to mount the universal coupler to the two shafts. This system also allows the universal coupler to be mounted and removed from the shafts without disassembling the universal coupler. However, this universal coupler uses a bolt to hold the end members together over the center puck. This bolt limits the amount the universal coupler can flex, and the bolt can break if the universal coupler is flexed too much, which would then allow the universal coupler to fall apart. What is needed is an improved universal coupler that is simpler to install in the field, with fewer parts and connections required to be assembled, and that is assembled in a way that allows for greater flexibility without breaking.

### SUMMARY

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

What is disclosed is a universal coupler having two members connected by a puck. The puck is flexible and resilient so as allow for flexibility and shock-absorption between the two members. The two members extend to two opposite ends of the universal coupler, a first end for connecting to a gearbox and a second end for connecting to a driveshaft.

The two members described above are called herein a driveline member and a gearbox member. The gearbox member is configured to connect to the output shaft of a drive motor gear box, or to the input shaft of a gearbox connected to one of the wheels. Typically the shaft of a gearbox has a round profile. The driveline member has a first end configured for connection to a driveshaft of a center pivot. Typically the driveshaft of a center pivot has a square profile.

The driveline member and gearbox member are functionally connected to a resilient puck between the driveline member and the gearbox member. The resilient puck is positioned between the driveline member and the gearbox member. Each of the driveline member and the gearbox member has a fixed set of opposing arms. The body of the puck (called the puck body) is press fit between each set of opposing arms to retain the puck in what would be a void between the assembled arms, which is herein referred to as the puck body space.

The puck has a series of spaced apart lobes extending outward from the circumference of the body. In the preferred embodiments the puck has four lobes. The lobes are spaced apart such that the opposing arms of each of the driveline member and the gearbox member extends between the lobes, such that the arms alternate with a lobe positioned between each driveline member arm and each gearbox member arm. The lobes serve to provide flexibility and shock absorption in connecting the drive shaft to the gear box.

The puck body is deformable so as to be press fit between the arms, and resilient so as to be prevented from the arms pulling off of the puck. In other words, the geometry of the puck is such that there is some interference between the puck and the arms when the puck is more biased toward the ends of the arms (away from the shaft at either end), and this interference is relieved when the puck is pressed into its operating position, although some interference between the arms and the puck may occur to maintain a tight fit. This fitment between the ends of the arms and the puck serve to keep the puck engaged between the members and the centerline of the ends generally centered and aligned, while allowing for flexibility.

The press fit arrangement is free of any pin or other retainer through the puck to secure the puck to either the driveline member or the gearbox member, with the press fit assembly securing the arms to the puck body. This secures the puck between the arms when the puck has been deformed in position within the arms.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF DRAWINGS

FIG. 1 illustrates an isometric view of a preferred embodiment of a universal coupler.

FIG. 2 illustrates an exploded section view of the embodiment of FIG. 1 illustrating the driveline member, puck, and gearbox member.

FIG. 3 illustrates a partially exploded isometric section view of the embodiment of FIG. 1.

FIG. 4 illustrates a section view of the embodiment of FIG. 1.

FIG. 5 illustrates an exploded view of the embodiment of FIG. 1.

FIG. 6 illustrates an isometric end view of the embodiment of FIG. 1.

FIG. 7 illustrates a section view of an embodiment of the invention having a hollow puck.

FIG. 8 illustrates an exploded view of the embodiment of FIG. 7.

FIG. 9 illustrates a section view of an embodiment of the invention having a puck retention feature and opposing feature on the puck body and arms of the coupler.

FIG. 10 illustrates an exploded view of the embodiment of FIG. 9.

FIG. 11 illustrates a section view of a second embodiment of the invention having a puck retention feature and opposing feature on the puck lobe and arms of the coupler.

FIG. 12 illustrates an exploded view of the embodiment of FIG. 11.

FIG. 13 illustrates a section view of an embodiment of the invention having a plug positioned within a bore in the body of the puck.

FIG. 14 illustrates an exploded view of the embodiment of FIG. 13.

FIG. 15 illustrates an isometric end view of an embodiment of the invention having a driveline coupler for varying sized driveshafts.

FIG. 16 illustrates an isometric view of the embodiment of FIG. 15.

### DETAILED DESCRIPTION OF THE FIGURES

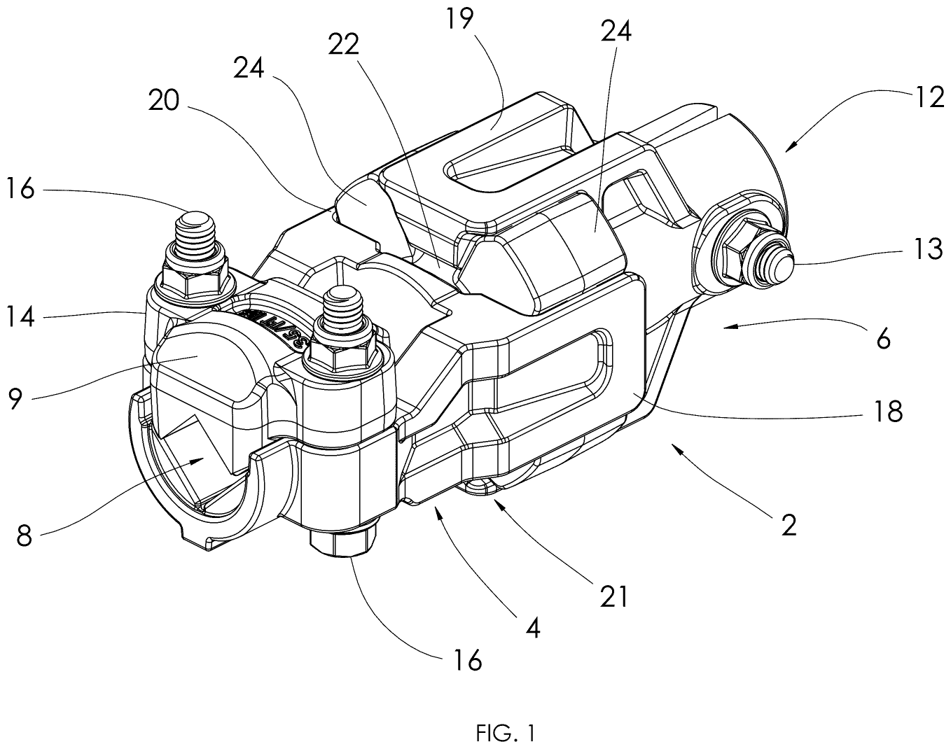

FIG. 1 illustrates an isometric view of a preferred embodiment of the invention. FIG. 1 illustrates the universal coupler 2 having a driveline member 4 and a gearbox member 6. The driveline member is configured with opening 8 for connection thereto of a torque driveshaft. The gearbox member 6 is configured with opening 12 into which the output shaft of the motor gearbox or input shaft of the wheel gearbox is positioned. The gearbox shaft is secured to the universal coupler 2 with through bolt 13. The driveshaft is connected to the driveshaft member by securing plate 9 and through bolts 16, which secures the driveshaft in the driveshaft member.

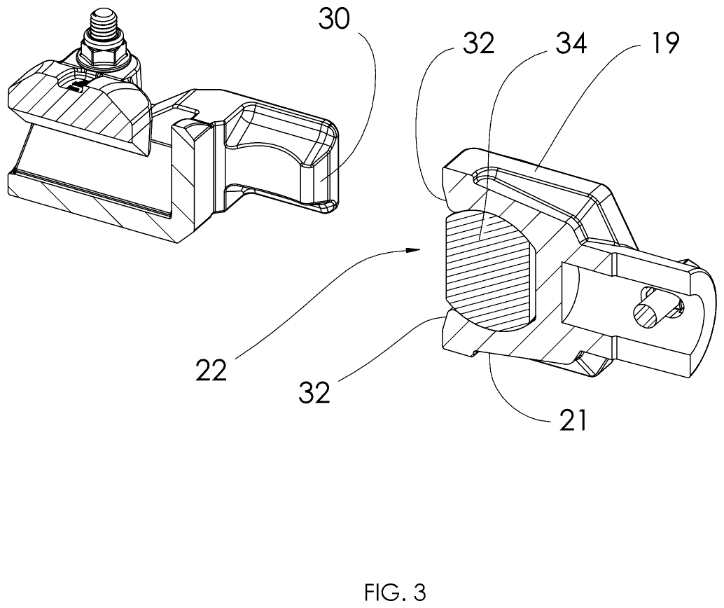

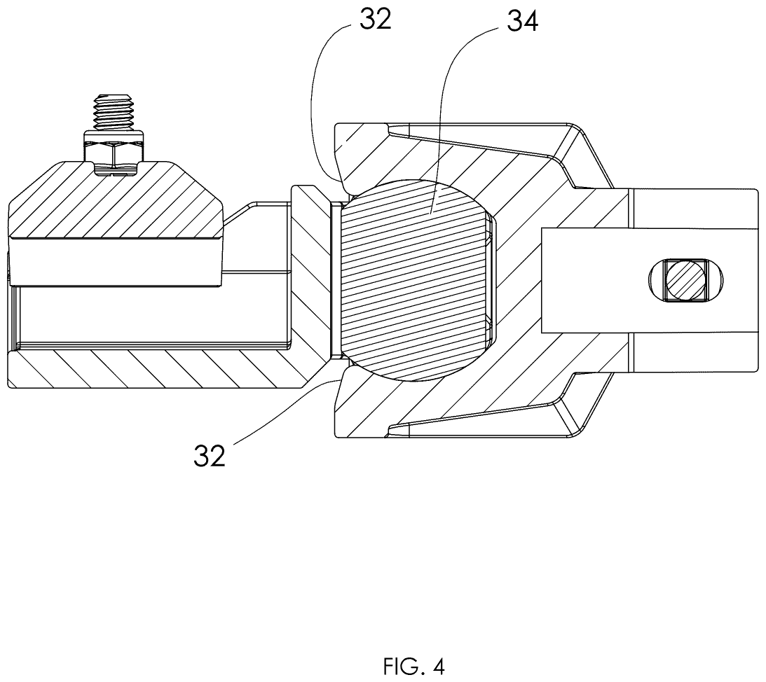

The driveshaft member 4 has opposing arms 18, 20. Each of the opposing arms has a slight bend or hook such that the distance between the ends of the opposing arms 30, 32 (shown in FIGS. 3 and 4) is less at the distal end of each arm than inward at the operating position of the puck. This configuration allows the puck to be pressed into place, and retained in position.

The gearbox member 6 has opposing arms 19, 21. A deformable puck 22 is positioned between the opposing arms of the driveline member and the gearbox member. The deformable puck has a central body 34 that is positioned within the void created between alignment of the opposing arms of each of the gearbox member and driveline member. The puck has four (4) lobes 24 that extend between the adjacent arms of the driveline member and the gearbox member. For example, lobe 24 is positioned between the arm 19 of the gearbox member and the arm 18 of the driveline member. As the universal coupler joint rotates to transmit rotational energy or torque, the puck lobes serve to transfer the energy between the rotating gear box shaft and the driveshaft.

Preferably, the body of the puck is spherical as shown in each of the figures. The puck body is deformable to allow it to be press fit into the arms of the members. When the puck is pressed fully into place, interference causing the deformation is relieved and the puck is retained in position between the arms of the members. The hooked or otherwise narrower ends of the arms 30, 32 of the opposing arms to retain the puck between the arms without having to utilize a separate connector, such as a rod or pin securing the puck to either member, or to keep the puck aligned with either member.

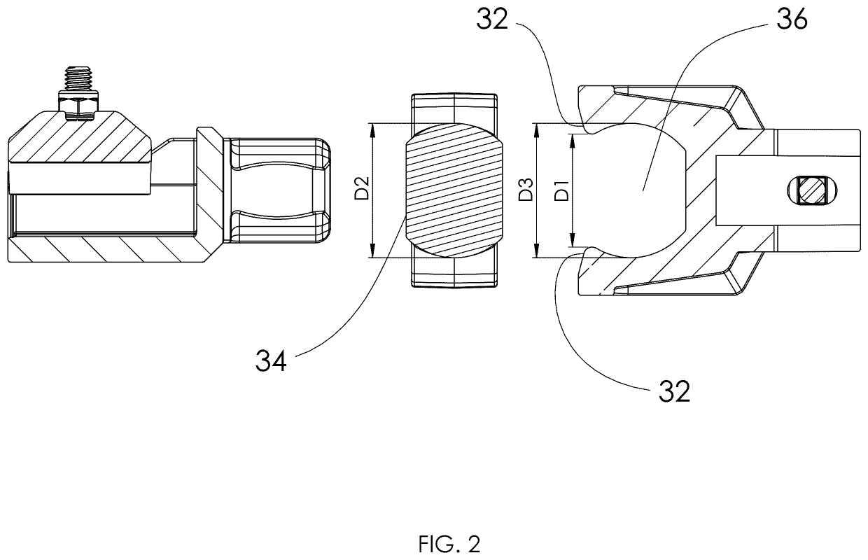

FIGS. 2 and 3 illustrate the body of the puck 34 relative to the opposing arms of the members. FIG. 2 illustrates a partially-exploded section view illustrating the members separate from the puck. The rounded puck body 34 is configured with a slightly larger diameter D2 than the distance between the arms at the opposing hooks D1. The puck body must be compressed slightly to fit between the arms at distance D1. As the puck body moves into void 36 the diameter D3 of the void is larger than distance D1. The resiliency of the puck body causes the puck body to expand to its diameter D2. The diameter of the puck body D2 being larger than distance D1 causes the puck to be retained in the void 36 by the ends 30, 32 of the arms 19, 21. A second void is positioned between opposing arms 18, 20 of the driveline member. The opposing arms of the driveline member have the same configuration as the opposing arms of the gearbox member providing for a void between the arms, with the distance between the ends of the arms being narrower than the body of the puck, allowing for the puck to be retained in the void by press fit engagement.

FIG. 2 illustrates the positioning of the rounded body of the puck between the opposing arms 19, 21 of the gearbox member. The rounded body of the puck is preferably approximately the same as diameter D3 when positioned between the opposing arms of the gearbox member, providing a secure or tight fit.

FIG. 3 illustrates a partially exploded section view of the opposing members with the puck 22 press fit into the opposing arms of the gearbox member. The body of the puck 34 is illustrated as positioned within the void 36, of FIG. 2. The body of the puck has been press fit between the opposing arms and once in position the puck is secured in position by the narrower ends of the arms 32. The puck is retained in position by narrower ends 30, 32 of the arms when the gearbox member is positioned onto the puck.

FIG. 4 illustrates a section view showing the opposing arms of the gearbox member connected to the body of the puck. The opposing arms of the driveline member are not shown but extend around the puck such that the four arms of the members are positioned around the body of the puck. FIG. 4 illustrates the puck body 34 retained in the void by the ends 32 of the opposing arms.

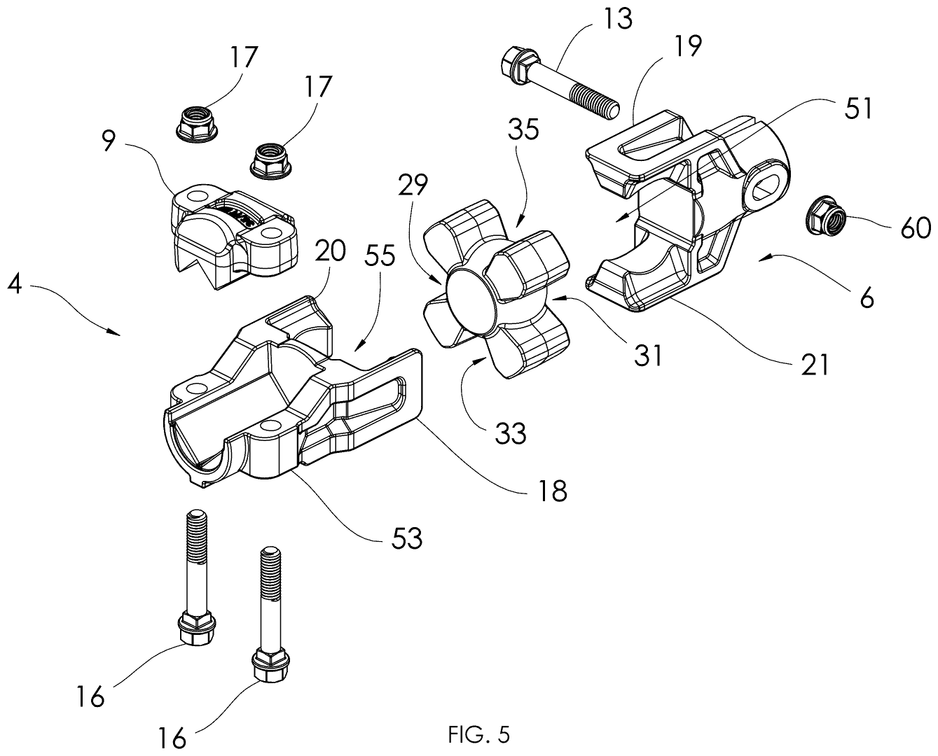

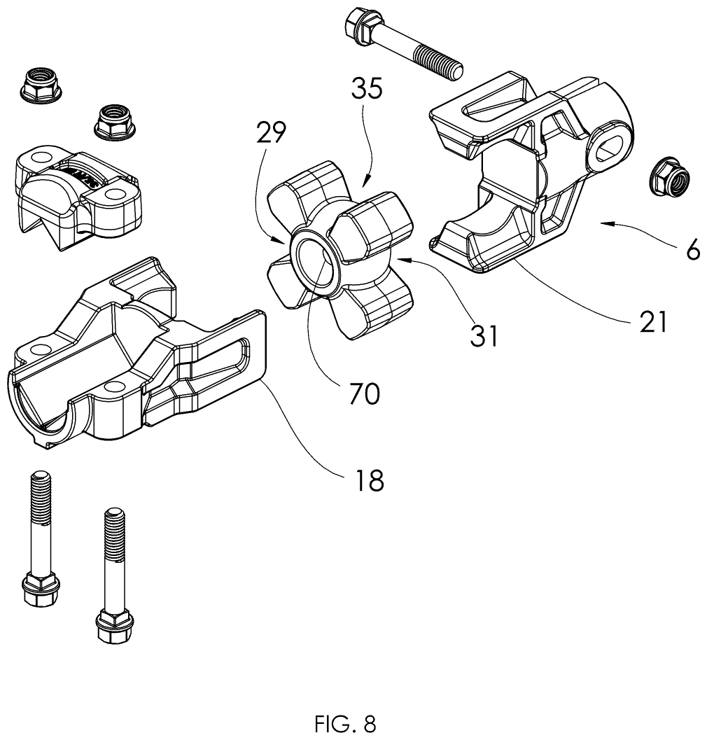

FIG. 5 illustrates an exploded view of the driveline member 4 and the gearbox member 6. The view of FIG. 5 illustrates the opposing arms of the driveline member 18, 20 oriented for positioning in the gaps or voids 29, 31 between the lobes of the puck. The opposing arms 19, 21 are positioned in the opposing gaps 33, 35 created by the lobes of the puck. The opposing arms of each of the members is fixed such that the puck is press fit into the opposing arms of each member. The driveline member 4 utilizes the driveline connector plate 9 that is secured to the member by through bolt 16 secured by nuts 17 to the body 53 of the driveline member. The puck body is secured between the arms of the member in the voids 51, 55 defined by the opposing pairs of arms. The puck body can be solid as shown in FIG. 5 or with a bore as shown in FIG. 8. The gearbox member 6 utilizes through bolt 13 and nut 60 to secure the gearbox shaft to the gearbox member. Preferably this end is a round opening as standard gearbox shafts are round. The driveline member end is typically a square as a typical driveshaft in a pivot or other overhead drive system of an irrigation system is square.

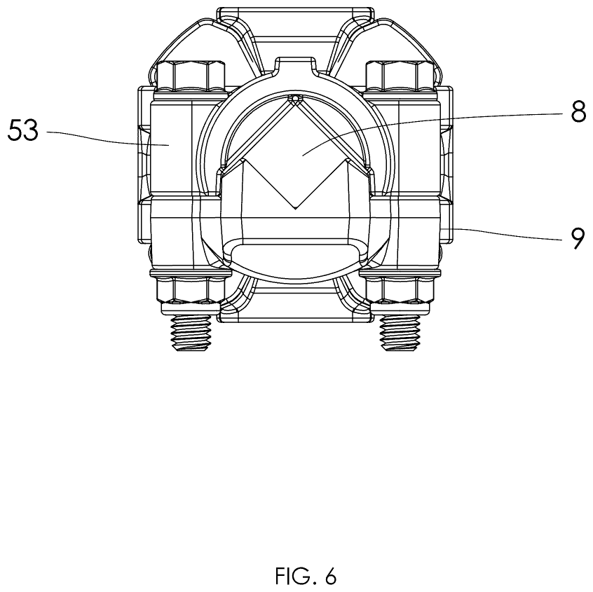

FIG. 6 depicts the square driveshaft input formed between plate 9 and the driveline member body 53 at opening 8.

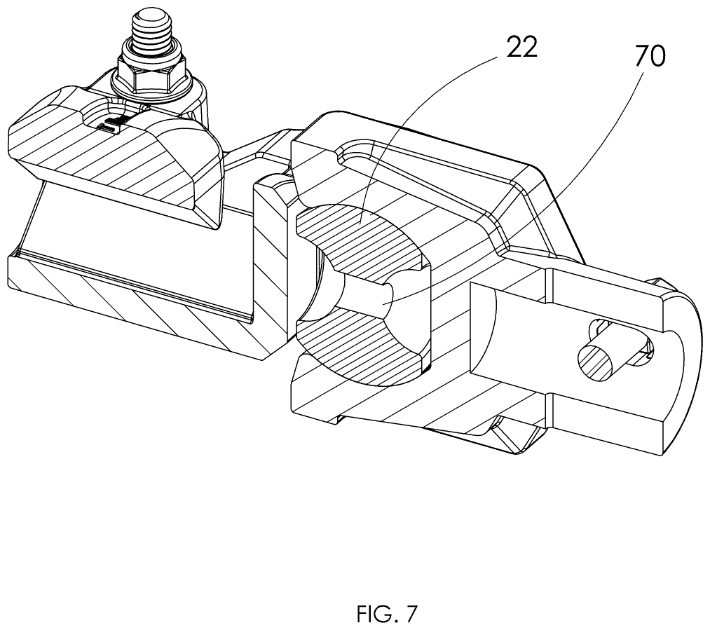

FIGS. 7 and 8 illustrate a puck 22 with a central bore 70. The puck can be constructed with or without a bore 70 to make the puck deform more easily when pressed into position.

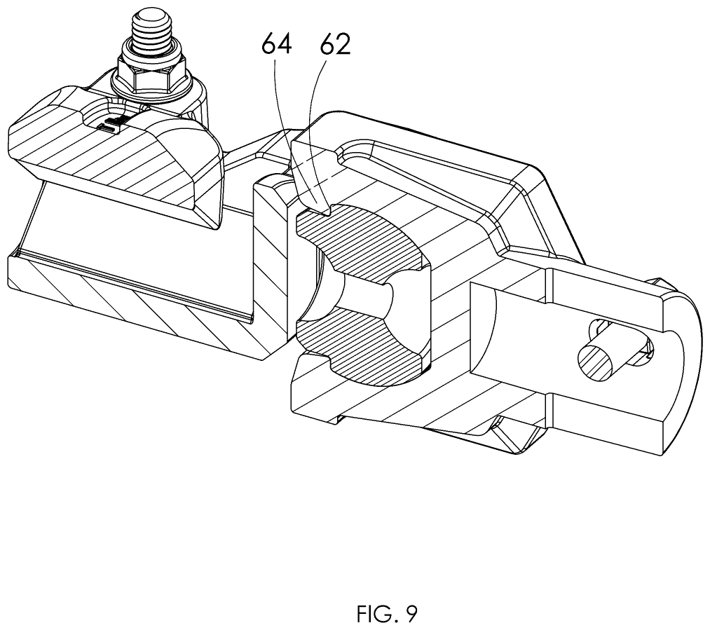

Preferably the puck and the arms of each member have puck retention features and opposing features for retaining the puck within the opposing arms of the coupler. FIG. 9 illustrates the retention features being a shelf or depression formed in the surface of the puck. The hook or overhang 64 of the arm is positioned in the shelf or recess 62 of the puck, preventing the puck from slipping out of or being pulled out of position between the opposing arms. This provides an example of a puck retention feature and opposing retention feature.

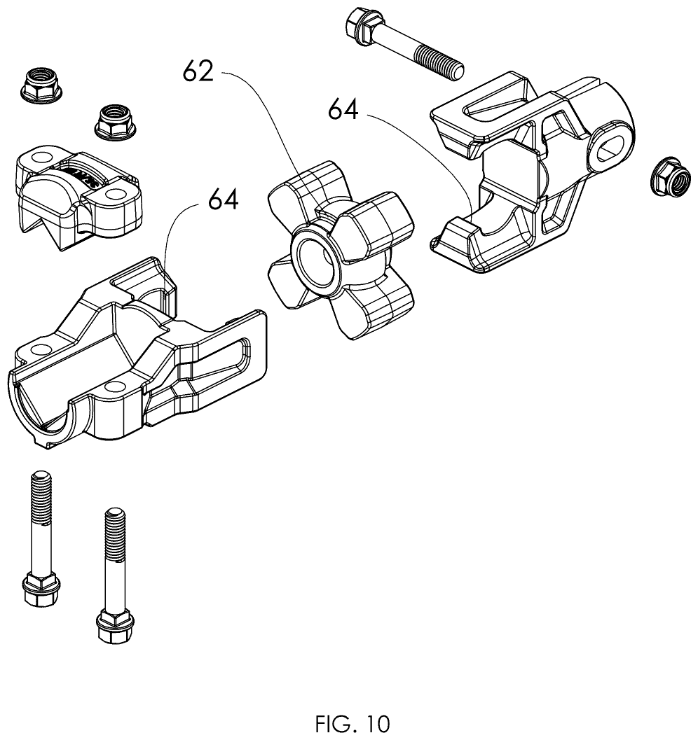

FIG. 10 provides an exploded view of the assembly of FIG. 9. The puck retention feature 62 and opposing retention feature 64 prevent the arms from being pulled off of the puck, or the puck being pulled out of the arms when in operation.

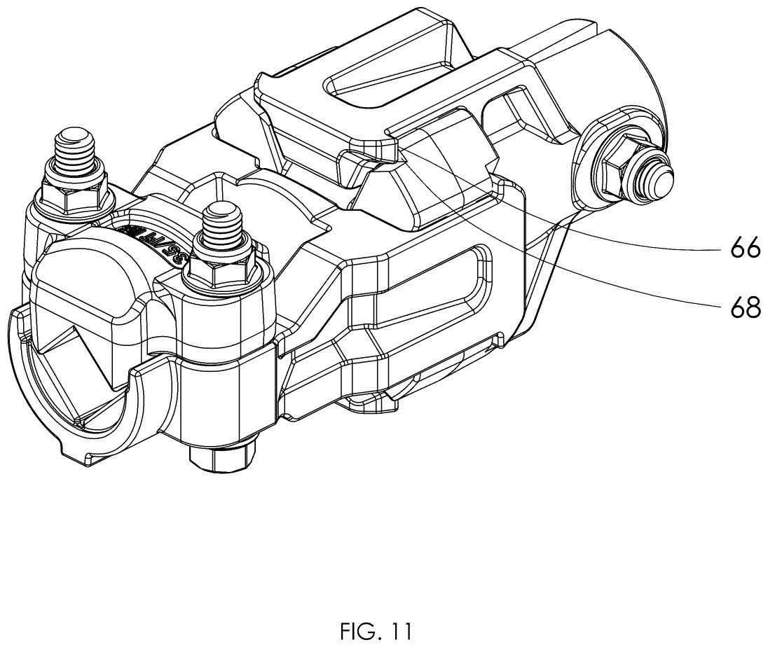

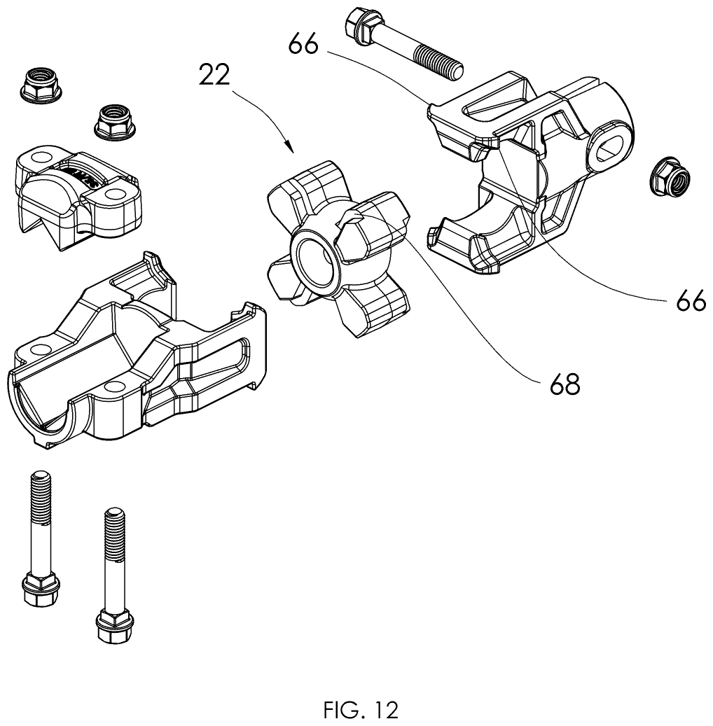

FIGS. 11-12 illustrates an example alternative for a puck retention feature and opposing retention feature. The puck retention feature is positioned on the side of the arm, with the mating opposing retention feature formed in the lobe of the puck. The arms have a projection 66 on the side of each arm that corresponds to a recess 68 in the puck lobe.

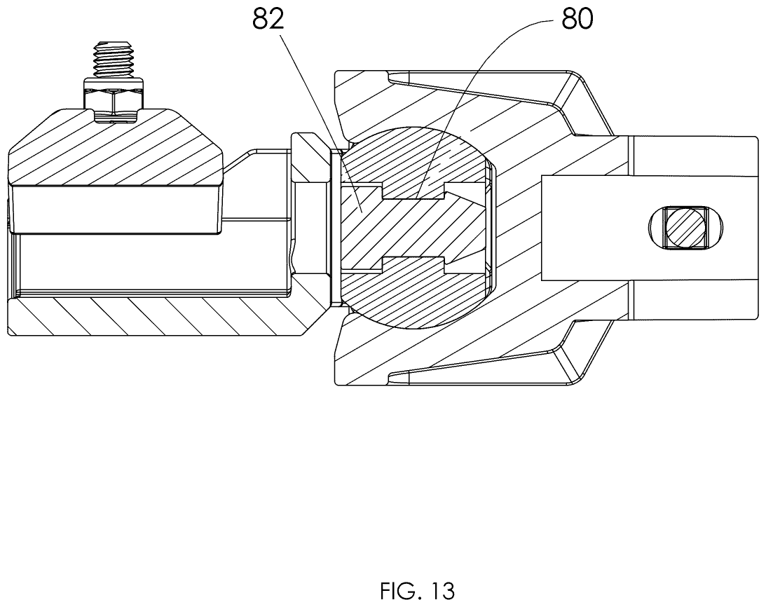

FIG. 13 illustrates a further embodiment of the puck. In the embodiment of FIG. 13, the puck has a bore 80 through the center of the puck. Once the puck is positioned into place, a plug 82 is positioned through the bore to maintain the rigidity of the puck and prevent the puck from deforming and being pulled out of position between the opposing arms of each member.

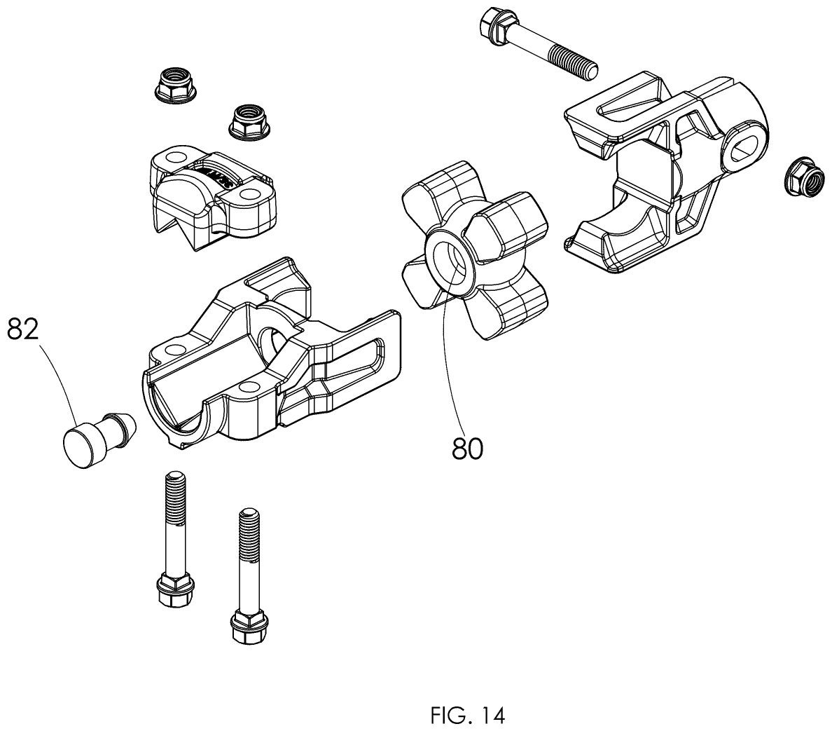

FIG. 14 illustrates an exploded view of the embodiment of FIG. 13. The plug 82 is configured for positioning through the bore 80 of the puck. This embodiment allows the puck to be easily deformed on assembly with the plug subsequently preventing deformation to allow the puck to be pulled out from the arms.

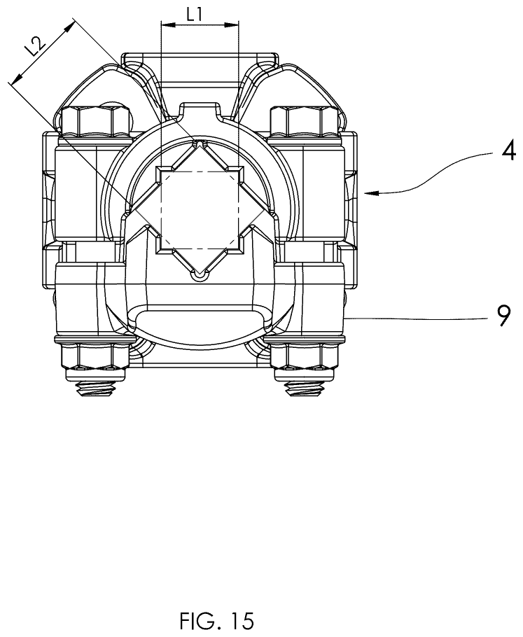

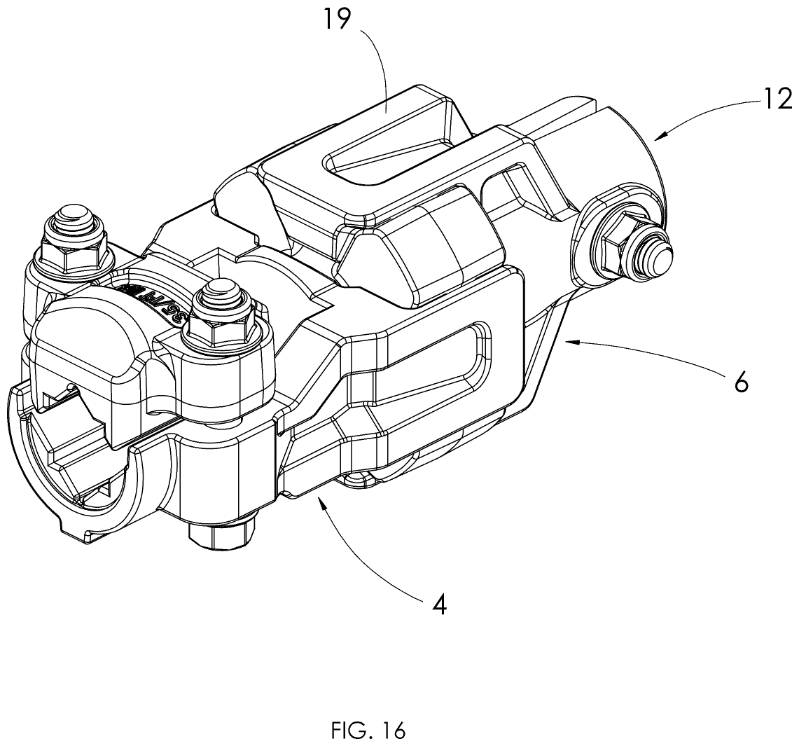

FIG. 15 illustrates a second example of the driveline member in which the driveline member is configured for attachment to different sized drive lines. The depicted embodiment is configured to accept square shafts of at least two sizes while keeping each size of shaft centered on the coupler. The first size square shaft is positioned in the box having side L1. The second size is outlined by a box having side L2 and is oriented at an angle offset from the box having side L1. FIG. 16 illustrates the end configuration of FIG. 15 in a fully assembled universal coupler.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

1. A driveline coupler for an irrigation system comprising:
a gearbox member having a first gearbox member end configured to connect to a shaft of a gearbox or motor, said gearbox member having a second gearbox member end comprising at least two opposing gearbox member puck arms;
a driveline member having a first driveline member end configured to connect to a driveshaft, said driveline member having a second driveline member end comprising at least two opposing driveline member puck arms;
a puck, said puck comprising a puck center body and at least four puck lobes extending outward from said puck center body; and
wherein said driveline member puck arms and said gearbox member puck arms are configured to be positioned together in an alternating relationship to define a puck void proximal to the ends of said driveline member puck arms and the ends of said gearbox member puck arms, wherein the distance between said driveline member puck arms at a distal end of each of said driveline member puck arms is less than the distance between said driveline member puck arms at said puck void, wherein the distance between said gearbox members puck arms at a distal end of each of said driveline member puck arms is less than the distance between said gearbox member puck arms at said puck void such that said puck center body is press fit into said puck void such that one of said lobes is positioned between each gearbox member arm and each driveline member arm.

2. The driveline coupler of claim 1 wherein each of said driveline member puck arms and each of said gearbox member puck arms comprises a puck retention feature, wherein said puck retention feature is configured to retain said puck in said puck void, wherein said puck comprises an opposing retention feature engaging said puck retention feature.

3. The driveline coupler of claim 2 wherein said puck retention feature comprises one of a projection and a recess, wherein said opposing retention feature comprises the other of a projection and a recess, wherein said projection and said recess are configured for mating engagement.

4. The driveline coupler of claim 2 wherein said center puck body comprises said opposing retention feature.

5. The driveline coupler of claim 2 wherein said puck lobes comprise said opposing retention feature.

6. The driveline coupler of claim 1 wherein said driveline member first end is configured for connecting to a first square driveshaft.

7. The driveline coupler of claim 4 wherein said driveline member first end is configured for connection to said first square driveshaft in a first position or to a second square driveshaft of different size than said first square driveshaft in a second position.

8. The driveline coupler of claim 1 wherein said puck comprises a bore.

9. The driveline coupler of claim 8 wherein said driveline coupler comprising a plug inserted into said bore to provide rigidity in said puck to maintain said puck in said puck center void.

10. The driveline coupler of claim 1 wherein said drive shaft member is connected to a securing member by a driveshaft plate.

11. The driveline coupler of claim 1 wherein said puck center body is solid.

12. A method of assembling a driveline coupler, said method comprising:
the step of providing a driveline coupler for an irrigation system comprising:
a gearbox member having a first gearbox member end configured to connect to a shaft of a gearbox or motor, said gearbox member having a second gearbox member end comprising at least two opposing gearbox member puck arms;
a driveline member having a first driveline member end configured to connect to a driveshaft, said driveline member having a second driveline member end comprising at least two opposing driveline member puck arms;
wherein said driveline member puck arms and said gearbox member puck arms are configured to be positioned together in an alternating relationship to define a puck void, wherein said driveline member puck arms and said gearbox member puck arms are configured to be positioned together in an alternating relationship to define a puck void proximal to the ends of said driveline member puck arms and said gearbox member puck arms, wherein the distance between said driveline member puck arms at a distal end of said driveline member puck ends is less than at said puck void, wherein the distance between said gearbox members puck arms is narrower than at said puck void;
the step of providing a puck, said puck comprising a puck center body having a diameter wider than the distance between said ends of said driveline member puck arms and the distance between said ends of said gearbox member puck arms, said puck comprising and at least four spaced apart puck lobes extending outward from said puck center body; and
the step of press fitting the puck body into the puck void, said step comprising the step of press fitting said puck body between said ends of said driveline member puck arms and said ends of said gearbox member puck arms such that one of said lobes is positioned between each gearbox member arm and each driveline member arm and said puck body is positioned in said puck void.

13. The method of claim 12, wherein said puck comprises a bore, wherein said method comprises the step of inserting a plug into said bore after said puck has been press fit into the puck void.

14. The method of claim 12 wherein said puck is solid.

15. The method of claim 12 wherein said driveline member is configured for connection to a square driveshaft.

16. The method of claim 12 wherein said driveline member is configured for connection to different sized driveshafts.
